(19) United States
(12) Patent Application Publication
(10) Pub. No.: US 2009/0195182 A1
(43) Pub. Date: Aug. 6, 2009

(54) Light Emission Control Circuit for Turning on a Plurality of Light Emitting Elements, and Lighting Apparatus and Portable Information Terminal Having the Same

(75) Inventor: Go Ezaki, Kyoto (JP)

Correspondence Address: FISH & RICHARDSON P.C., P.O. BOX 1022, MINNEAPOLIS, MN, 55440-1022, US

(73) Assignee: Rohm Co., Ltd., Kyoto (JP)

(21) Appl. No.: 11/915,414

(22) PCT Filed: Jun. 9, 2006
(86) PCT No.: PCT/JP2006/311588

§ 371 Date: Nov. 26, 2007

(30) Foreign Application Priority Data
Jun. 20, 2005 (JP) 2005-179372

(51) Int. Cl. H05B 37/02

(52) U.S. Cl. 315/294

(57) ABSTRACT

A light emission control circuit includes a current source circuit for generating currents to be supplied to a plurality of light emitting elements, a plurality of switches disposed corresponding to the respective light emitting elements for switching between supplying or not supplying the currents generated by the current source circuit to the respective light emitting elements, and a PWM control circuit for controlling the respective switches to intermittently supply the currents generated by the current source circuit to the respective light emitting elements and to switch from a stopped state to an initiated state of current supply at different timings for each light emitting element.

### TECHNICAL FIELD

The present invention relates to a light emission control circuit, and a lighting apparatus and a portable information terminal having the same. In particular, the present invention relates to a light emission control circuit for turning on a plurality of light emitting elements, and a lighting apparatus and a portable information terminal having the same.

### BACKGROUND ART

Portable information terminals such as portable telephones and PDAs (Personal Data Assistant) employ LED (Light-Emitting Diode) elements for various purposes, for example, as backlights of LCD (Liquid Crystal Display) devices or flashlights of cameras using CCDs (Charge-Coupled Device) or illuminations based on blinking of LED elements with different light emission colors.

A method for adjusting the luminance of an LED by PWM (Pulse Width Modulation) control is known. The PWM control is a method for adjusting the luminance of an LED by changing the pulse width (duration) of a current flowing through the LED, that is, changing the duty ratio of the pulse of a current flowing through the LED.

For example, Japanese Patent Laying-Open No. 2002-111786 (Patent Document 1) discloses a light emission control circuit which will be described below. Specifically, the light emission control circuit of a portable telephone, which operates by the power of a battery together with a communication circuit, includes a plurality of light emitting elements having different light emission colors, which are driven individually by a pulse width modulation method. It also includes a voltage boosting circuit having a smoothing circuit connected to an output side thereof, whose output is supplied to the light emitting elements.
Patent Document 1: Japanese Patent Laying-Open No. 2002-111786

### DISCLOSURE OF THE INVENTION

### Problems To Be Solved By the Invention

In order to turn on light emitting elements, a prescribed voltage which is greater than or equal to the forward voltage (Vf) of the light emitting elements needs to be applied to the light emitting elements. In the light emission control circuit according to Patent Document 1, however, currents will be supplied simultaneously to the plurality of light emitting elements at the transition from the turned-off state to the turned-on state of the plurality of light emitting elements. Consequently, the output current of the voltage boosting circuit surges, so that the output voltage of the voltage boosting circuit will temporarily drop significantly if the smoothing circuit does not have enough capability. In this situation, the light emitting elements cannot be turned on until the prescribed voltage is applied thereto. Therefore, the light emission control circuit according to Patent Document 1 may lead to uneven luminance and color tone due to the increase in delay time from when the plurality of light emitting elements are controlled to be turned on till when the respective light emitting elements are actually turned on.

An object of the present invention is, therefore, to provide a light emission control circuit capable of reducing the occurrence of uneven luminance and color tone by preventing the increase in delay time from when a plurality of light emitting elements are controlled to be turned on till when the respective light emitting elements are actually turned on, and a lighting apparatus and a portable information terminal having the same.

### Means For Solving the Problems

A light emission control circuit for turning on a plurality of light emitting elements according to an aspect of the present invention includes a current source circuit for generating currents to be supplied to the respective light emitting elements, a plurality of switches disposed corresponding to the respective light emitting elements for switching between supplying or not supplying the currents generated by the current source circuit to the respective light emitting elements, and a control circuit for controlling the respective switches to intermittently supply the currents generated by the current source circuit to the respective light emitting elements and to switch from a stopped state to an initiated state of current supply at different timings for each light emitting element.

Preferably, the control circuit supplies the currents to the respective light emitting elements at an equal cycle and sets a different initiation timing of the cycle for each light emitting element.

Still preferably, the control circuit sets the different initiation timing of the cycle for each light emitting element at regular intervals.

Still preferably, the interval is the time which is longer than or equal to the time required for the output voltage of a power supply circuit which applies voltages to the respective light emitting elements to be stabilized.

Preferably, the plurality of light emitting elements are LEDs which are used as a backlight of a display device employing the field sequential method.

Still preferably, the plurality of light emitting elements are LEDs corresponding to the same color among the LEDs with a plurality of colors which are used as a backlight of a display device employing the field sequential method.

A light emission control circuit for turning on a plurality of light emitting elements according to another aspect of the present invention includes a current source circuit for generating currents to be supplied to the respective light emitting elements, a plurality of switches disposed corresponding to the respective light emitting elements for switching between supplying or not supplying the currents generated by the current source circuit to the respective light emitting elements, a control circuit for controlling the respective switches to intermittently supply the currents generated by the current source circuit to the respective light emitting elements, and a plurality of delay circuits disposed corresponding to the respective light emitting elements for setting a different timing of switch control by the control circuit for each light emitting element.

A lighting apparatus according to an aspect of the present invention includes a plurality of light emitting elements, a current source circuit for generating currents to be supplied to the respective light emitting elements, a plurality of switches disposed corresponding to the respective light emitting elements for switching between supplying or not supplying the currents generated by the current source circuit to the respective light emitting elements, and a control circuit for controlling the respective switches to intermittently supply the currents generated by the current source circuit to the respective light emitting elements and to switch from a stopped state to an initiated state of current supply at different timings for each light emitting element.

A portable information terminal according to an aspect of the present invention includes a light emission control circuit for turning on a plurality of light emitting elements, and the light emission control circuit includes a current source circuit for generating currents to be supplied to the respective light emitting elements, a plurality of switches disposed corresponding to the respective light emitting elements for switching between supplying or not supplying the currents generated by the current source circuit to the respective light emitting elements, and a control circuit for controlling the respective switches to intermittently supply the currents generated by the current source circuit to the respective light emitting elements and to switch from a stopped state to an initiated state of current supply at different timings for each light emitting element.

### Effects of the Invention

The present invention allows the occurrence of uneven luminance and color tone to be reduced by preventing the increase in delay time from when a plurality of light emitting elements are controlled to be turned on till when the respective light emitting elements are actually turned on. Moreover, the present invention allows the area of a voltage boosting circuit, a smoothing circuit and the like to be reduced to downsize the overall equipment because these circuits do not need to have greater capability than necessary.

### BRIEF DESCRIPTION OF THE DRAWINGS

FIG. 1 is a functional block diagram of a configuration of a light emission control circuit according to a first embodiment of the present invention.

FIG. 2 is a diagram respectively showing currents Io1-Io3 flowing through light emitting elements D1-D3 and a power supply current Ibat to be supplied from a power supply to a voltage boosting circuit 2 when the conventional PWM control is exercised.

FIG. 3 is a diagram respectively showing currents Io1-Io3 flowing through light emitting elements D1-D3 and a power supply current Ibat to be supplied from a power supply to a voltage boosting circuit 2 when the light emission control circuit according to the first embodiment of the present invention applies the PWM control to light emitting elements D1-D3.

FIG. 4 is a diagram of a configuration of a portable information terminal having the light emission control circuit according to the first embodiment of the present invention.

FIG. 5 is a circuit diagram of a configuration of a light emission control circuit according to a second embodiment of the present invention.

FIG. 6 is a circuit diagram of a configuration of a light emission control circuit according to a third embodiment of the present invention.

### DESCRIPTION OF THE REFERENCE SIGNS

SW1-SW9: switch, D1-D9: light emitting element, K1-K9: constant current driver (current source circuit), DL1-DL3: delay circuit, 1: PWM control circuit, 2: voltage boosting circuit, 11: operation unit, 12: light emitting unit, 13: processing block, 14: communication processing unit, 15: LCD monitor, 21: LED, 22: processing unit, 23: CPU, 24: memory, 31-32, 100: light emission control circuit, 200: portable information terminal

### BEST MODES FOR CARRYING OUT THE INVENTION

The embodiments of the present invention will be described hereinafter with reference to the accompanying drawings. The same or corresponding parts are represented by the same reference numerals and the description thereof will not be repeated.

### First Embodiment

### Configuration And Basic Operation

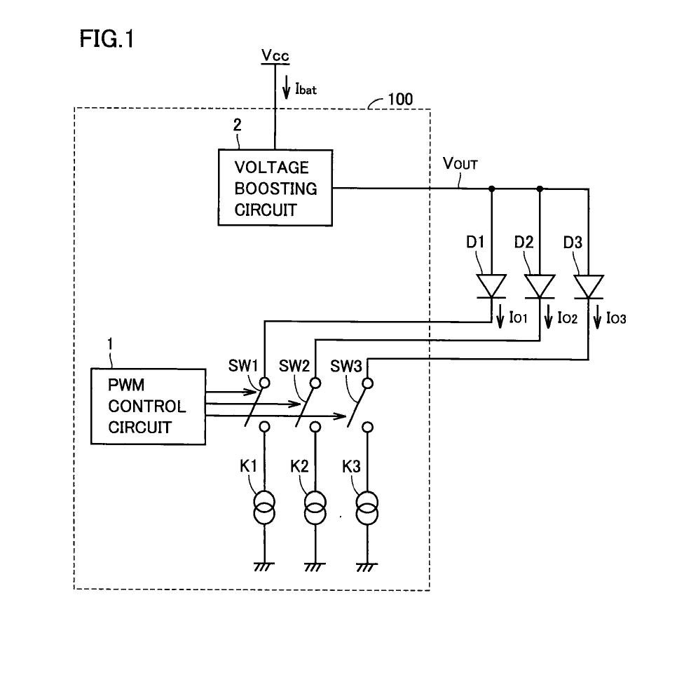

FIG. 1 is a functional block diagram of a configuration of a light emission control circuit according to a first embodiment of the present invention. Referring to FIG. 1, a light emission control circuit 100 includes a PWM control circuit 1, a voltage boosting circuit 2, switches SW1-SW3, and constant current drivers (drive circuits, that is, current source circuits) K1-K3.

Voltage boosting circuit 2 boosts a power supply voltage Vcc supplied from a power supply (not shown) to a prescribed voltage to supply the boosted voltage to light emitting elements D1-D3. Constant current drivers K1-K3 respectively supply prescribed currents to light emitting elements D1-D3.

Switches SW1-SW3 switch between supplying or not supplying the currents generated by constant current drivers K1-K3 to the respective light emitting elements D1-D3, based on the control by PWM control circuit 1.

PWM control circuit 1 controls respective switches SW1-SW3 to cyclically supply the currents generated by constant current drivers K1-K3 to the respective light emitting elements D1-D3 based on the pulse width modulation method.

### Operation

The operation when the light emission control circuit according to the present embodiment applies the PWM control to the light emitting elements will be described afterwards.

First, for sake of comparison, the operation when the conventional PWM control is exercised in the light emission control circuit according to the present embodiment will be described.

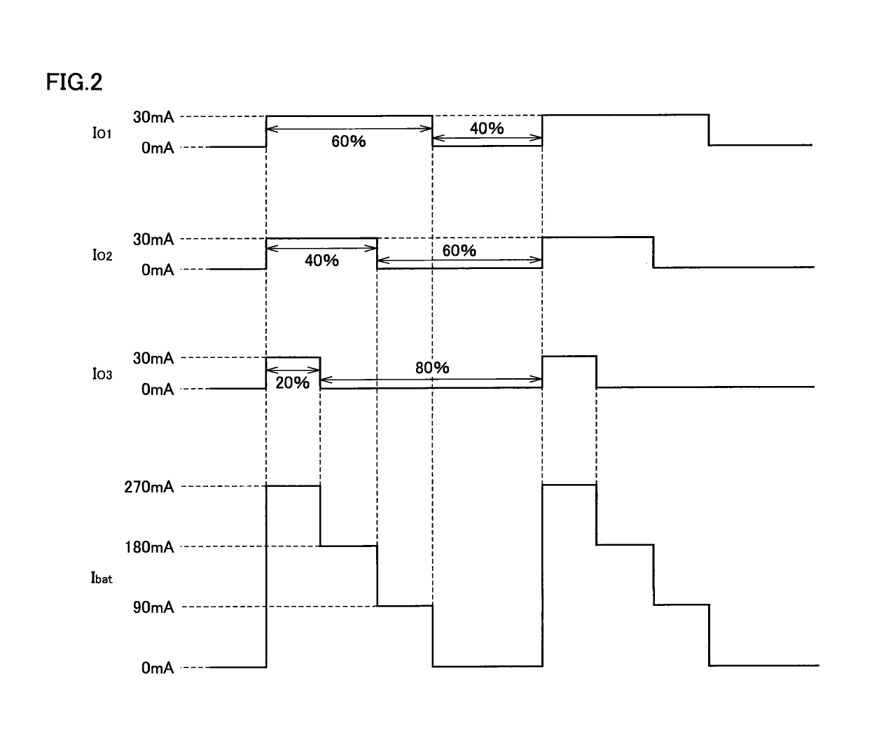

FIG. 2 is a diagram respectively showing currents Io1-Io3 flowing through light emitting elements D1-D3 and a power supply current Ibat to be supplied from a power supply to a voltage boosting circuit 2 when the conventional PWM control is exercised. The description is based on the assumption that the respective consumption currents in turning on light emitting elements D1-D3 are 30 mA, and voltage boosting circuit 2 boosts a power supply voltage Vcc of 3.6V, for example, to 8V and a current of three times as large as the output current needs to be supplied from the power supply for this voltage boosting. The description is also based on the assumption that light emitting elements D1-D3 have different characteristics such as red (R), green (G) and blue (B), luminance and the like, so they have different duration for which a current is supplied, that is, a different duty ratio.

Referring to FIG. 2, currents at the duty ratio of 60%, 40% and 20% are supplied to light emitting elements D1-D3, respectively, based on the pulse width modulation method. Moreover, the current supply to the respective light emitting elements is initiated at the same timing. Currents Io1-Io3 are 30 mA respectively when light emitting elements D1-D3 are turned on, but power supply current Ibat to be supplied from the power supply to voltage boosting circuit 2 is 90 mA for each light emitting element. Consequently, an abrupt load change from 0 mA to 270 mA occurs. That is, the output current of voltage boosting circuit 2 is raised suddenly from 0 mA to 270 mA. Therefore, after the output voltage of voltage boosting circuit 2 temporarily drops, the conventional PWM control circuit waits for the output voltage of voltage boosting circuit 2 to recover and then starts to supply currents to turn on light emitting elements D1-D3. That is, the delay time from when PWM control circuit 1 turns switches SW1-SW3 from the OFF state to the ON state till when light emitting elements D1-D3 are actually turned on is increased. On the other hand, if the conventional PWM control circuit does not wait for the output voltage to recover, a time lag occurs in timings when the respective light emitting elements emit light, with difference in luminance of each light emitting element.

In comparison, a light emission control circuit according to the present embodiment switches from a stopped state to an initiated state of current supply at different timings for each light emitting element.

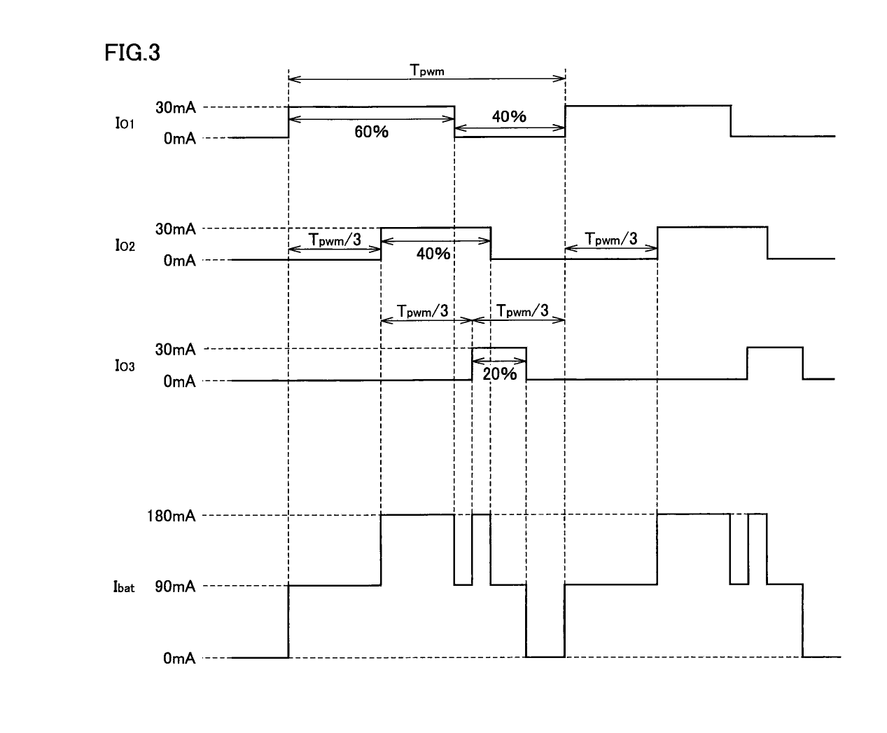

FIG. 3 is a diagram respectively showing currents Io1-Io3 flowing through light emitting elements D1-D3 and a power supply current Ibat to be supplied from a power supply to a voltage boosting circuit 2 when the light emission control circuit according to the first embodiment of the present invention applies the PWM control to light emitting elements D1-D3. Tpwm is a cycle of the PWM modulation method performed by PWM control circuit 1. The other components in FIG. 3 are similar to those in FIG. 2.

PWM control circuit 1 controls switches SW1-SW3 to supply currents generated by constant current drivers K1-K3 to the respective light emitting elements D1-D3 based on the pulse width modulation method with a cycle of Tpwm, and to switch from a stopped state to an initiated state of current supply to the respective light emitting elements at an interval of Tpwm/3.

First, immediately before a cycle of the PWM modulation method begins, PWM control circuit 1 keeps all switches SW1-SW3 in the OFF state and does not supply currents to light emitting elements D1-D3.

At the initiation of the cycle of the PWM modulation method, PWM control circuit 1 turns switch SW1 into the ON state to initiate supply of the current to light emitting element D1. The output current of voltage boosting circuit 2 changes from 0 mA to 90 mA, so the load change is 90 mA.

At the elapse of Tpwm/3 since initiation of current supply to light emitting element D1, PWM control circuit 1 turns switch SW2 into the ON state to initiate supply of the current to light emitting element D2. The output current of voltage boosting circuit 2 changes from 90 mA to 180 mA, so the load change is 90 mA.

Then, PWM control circuit 1 turns switch SW1 into the OFF state to stop supply of the current to light emitting element D1. The output current of voltage boosting circuit 2 changes from 180 mA to 90 mA.

At the elapse of Tpwm/3 since initiation of current supply to light emitting element D2, PWM control circuit 1 turns switch SW3 into the ON state to initiate supply of the current to light emitting element D3. The output current of voltage boosting circuit 2 changes from 90 mA to 180 mA, so the load change is 90 mA.

Then, PWM control circuit 1 turns switch SW2 into the OFF state to stop supply of the current to light emitting element D2. The output current of voltage boosting circuit 2 changes from 180 mA to 90 mA.

Then, PWM control circuit 1 turns switch SW3 into the OFF state to stop supply of the current to light emitting element D3. The output current of voltage boosting circuit 2 changes from 90 mA to 0 mA.

At the elapse of Tpwm/3 since initiation of current supply to light emitting element D3, that is, at the initiation of the next cycle of the PWM modulation method, PWM control circuit 1 turns switch SW1 into the ON state again to initiate supply of the current to light emitting element D1.

In the light emission control circuit according to Patent Document 1, currents will be supplied simultaneously to the plurality of light emitting elements at the transition from the turned-off state to the turned-on state. Consequently, the output voltage of the voltage boosting circuit will temporarily drop significantly. Therefore, the delay time from when the plurality of light emitting elements are controlled to be turned on till when the respective light emitting elements are actually turned on is increased.

The light emission control circuit according to the present embodiment, however, switches from a stopped state to an initiated state of current supply at different timings for each light emitting element, so the load change can be reduced to the current required for turning on one light emitting element, that is, 90 mA. Therefore, the light emission control circuit according to the present embodiment can prevent the increase in delay time from when the plurality of light emitting elements are controlled to be turned on till when the respective light emitting elements are actually turned on.

Furthermore, in the light emission control circuit according to the present embodiment, PWM control circuit 1 controls switches SW1-SW3 to supply currents to light emitting elements D1-D3 at an equal cycle. Since the light emission control circuit according to the present embodiment is configured in the above-described manner, the configuration of PWM control circuit 1 and control for turning on light emitting elements D1-D3 can be simplified.

Moreover, in the light emission control circuit according to the present embodiment, PWM control circuit 1 switches from a stopped state to an initiated state of current supply to the respective light emitting elements at an interval of Tpwm/3. By setting initiation timings such that currents are supplied to light emitting elements D1-D3 cyclically at regular intervals as described above, the configuration of PWM control circuit 1 and control for turning on light emitting elements D1-D3 can be simplified still further. It should be noted that the timing when PWM control circuit 1 switches the current supply to the respective light emitting elements is not limited to an interval of Tpwm/3, that is, an interval of (Tpwm/the number of light emitting elements). The current supply to the respective light emitting elements may be switched at a shorter interval than the interval of (Tpwm/the number of light emitting elements) if the interval is longer than or equal to the time required for the output voltage of a power supply circuit such as a voltage boosting circuit which applies voltages to the light emitting elements to be stabilized.

### Lighting Apparatus

The present invention is also applicable to a lighting apparatus. That is, the lighting apparatus is configured to include light emitting elements D1-D3 in addition to the light emission control circuit according to the first embodiment shown in FIG. 1.

### Portable Information Terminal

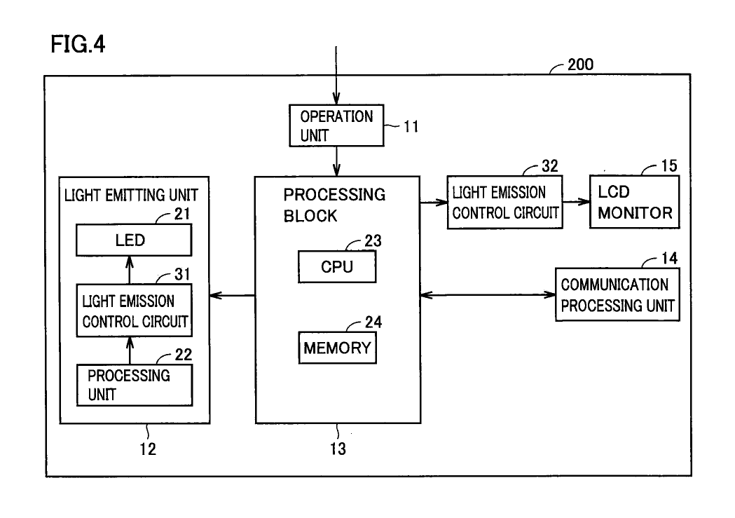

FIG. 4 is a diagram of a configuration of a portable information terminal having the light emission control circuit according to the first embodiment of the present invention.

Referring to FIG. 4, a portable information terminal 200 includes light emission control circuits 31-32, an operation unit 11, a light emitting unit 12, a processing block 13, a communication processing unit 14, and an LCD monitor 15. Light emitting unit 12 includes an LED 21 and a processing unit 22. Processing block 13 includes a CPU (Central Processing Unit) 23 and a memory 24. Light emission control circuits 31-32 correspond to light emission control circuit 100.

The following description is based on the assumption that a portable information terminal is a portable telephone. Alternatively, the portable information terminal may be a PDA or the like.

Communication processing unit 14 performs processing required for communication. More specifically, communication processing unit 14 performs processing required for communication in the mobile communication system such as PDC (Personal Digital Cellular) System, Personal Handyphone System, CDMA (Code Division Multiple Access) method, IrDA (Infrared Data Association) method, and the like.

Operation unit 11 includes buttons that enable users to input telephone numbers or the like, and detects users' operations.

Light emitting unit 12 causes LED 21 to blink as illuminations when a portable telephone has an incoming call. Processing unit 22 performs processing to cause blinking of LED 21. More specifically, processing unit 22 outputs a control signal corresponding to an instruction for blinking of LED 21 to PWM control circuit 1 which is included in light emission control circuit 31. Then, light emission control circuit 31 supplies the current to LED 21 based on the control signal received from processing unit 22, and causes LED 21 to blink.

Processing block 13 controls each block of the portable telephone.

LCD monitor 15 displays the telephone number of the caller of communication, contents of e-mail, images or the like. Processing block 13 causes LCD monitor 15 to display images or the like and outputs a control signal to PWM control circuit 1 in light emission control circuit 32. Then, light emission control circuit 31 supplies the current to an LED which is included in LCD monitor 15, based on the control signal received from processing block 13.

Another embodiment of the present invention will then be described with reference to the drawings. The same or corresponding parts are represented by the same reference numerals and the description thereof will not be repeated.

### Second Embodiment

The present embodiment corresponds to the known field sequential method, and relates to a light emission control circuit for controlling a larger number of light emitting elements, compared to the light emission control circuit of the first embodiment.

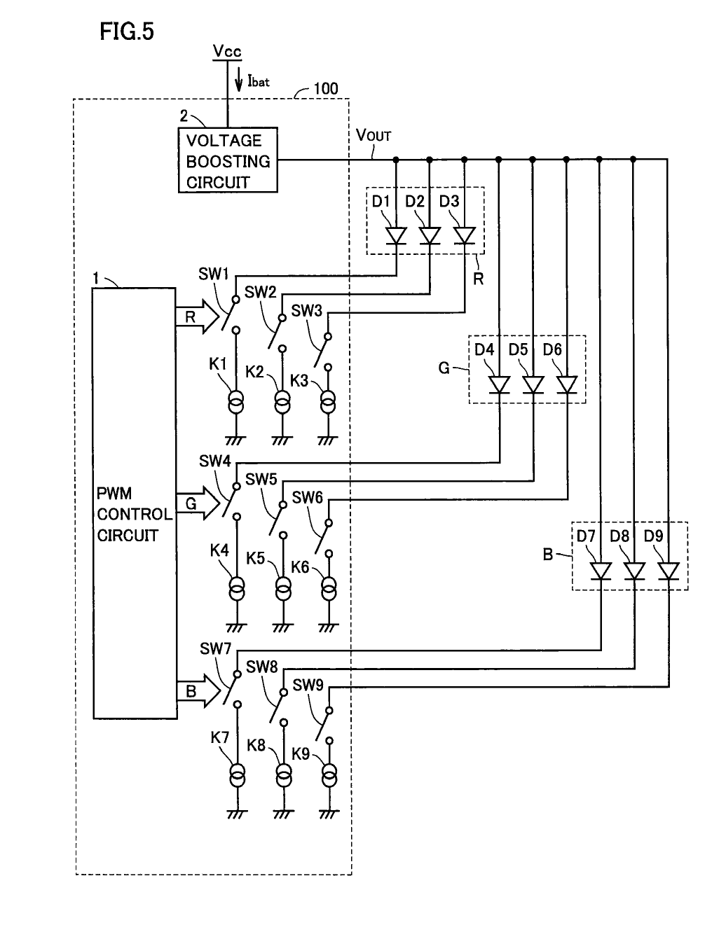

FIG. 5 is a circuit diagram of a configuration of a light emission control circuit according to a second embodiment of the present invention. Referring to FIG. 5, a light emission control circuit 100 additionally includes light emitting elements D4-D9, SW4-SW9 and constant current drivers (drive circuits, that is, current source circuits) K4-K9, compared to the light emission control circuit according to the first embodiment.

Light emitting elements D1-D3 emit light in red (R), light emitting elements D4-D6 emit light in green (G), and light emitting elements D7-D9 emit light in blue (B).

A PWM control circuit 1 controls switches SW1-SW9 to cyclically supply currents generated by constant current drivers K1-K9 to light emitting elements D1-D9 at the duty ratio corresponding to each color, that is, R, G and B.

PWM control circuit 1 controls switches SW1-SW9 to turn on light emitting elements D1-D3 corresponding to R, light emitting elements D4-D6 corresponding to G and light emitting elements D7-D9 corresponding to B in a time-divisional manner within one frame for each color. Furthermore, for the time-divided lighting period of each color, PWM control circuit 1 effects switching from a stopped state to an initiated state of current supply at different timings for each light emitting element.

By using light emitting elements D1-D9 as a backlight of an LCD display device and rapidly switching the backlight of a liquid crystal filter in the LCD display device, full-color images are displayed due to the afterimage effect of eyes.

Other configuration and operation of the present embodiment are similar to those of the light emission control circuit according to the first embodiment. Therefore, the light emission control circuit according to the present embodiment can prevent the increase in delay time from when the plurality of light emitting elements are controlled to be turned on till when the respective light emitting elements are actually turned on, as is similar to the light emission control circuit of the first embodiment.

One frame corresponds to, for example, 1/60 second, so it is required that sets of light emitting elements corresponding to each color, R, G and B, that is, light emitting elements D1-D3, light emitting elements D4-D6 and light emitting elements D7-D9 should be switched respectively at 1/180 second between a turned-on state and a turned-off state. Therefore, if the light emission control circuit according to the present embodiment is used for a backlight of an LCD display device employing the known field sequential method, significant advantages can be offered because a plurality of light emitting elements can have stable luminance by preventing the increase in delay time from when the plurality of light emitting elements are controlled to be turned on till when the respective light emitting elements are actually turned on, as well as preventing the rapid increase in supplied currents. Significant advantages can also be offered if, in the light emission control circuit according to the first embodiment, light emitting elements D1-D3 correspond to light emitting elements with the same color among light emitting elements with a plurality of colors which are used as a backlight of an LCD display device employing the known field sequential method.

Another embodiment of the present invention will then be described with reference to the drawings. The same or corresponding parts are represented by the same reference numerals and the description thereof will not be repeated.

### Third Embodiment

The present embodiment relates to a light emission control circuit where control of a PWM control circuit 1 is simplified.

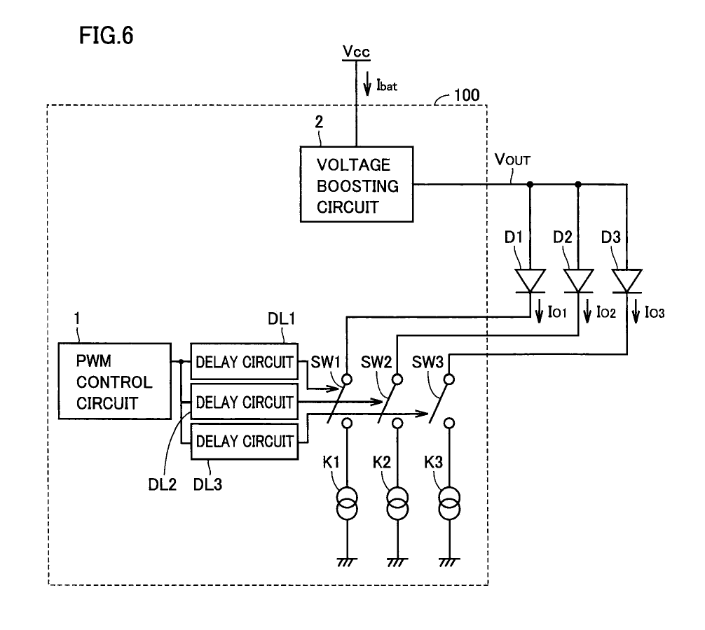

FIG. 6 is a circuit diagram of a configuration of a light emission control circuit according to a third embodiment of the present invention. Referring to FIG. 6, a light emission control circuit 100 additionally includes delay circuits DL1-DL3, compared to the light emission control circuit according to the first embodiment.

Switches SW1-SW3 switch between supplying or not supplying currents generated by constant current drivers K1-K3 to the respective light emitting elements D1-D3, based on a control signal received from PWM control circuit 1 via delay circuits DL1-DL3.

PWM control circuit 1 outputs a common control signal via delay circuits DL1-DL3 to switches SW1-SW3, and cyclically supplies the currents generated by constant current drivers K1-K3 to light emitting elements D1-D3 based on the pulse width modulation method.

Delay circuits DL1-DL3 respectively delay the control signal received from PWM control circuit 1 by different times and output the delayed control signal to switches SW1-SW3. That is, delay circuits DL1-DL3 set a different control timing of switches SW1-SW3 by PWM control circuit 1 for each light emitting element.

Other configuration and operation of the present embodiment are similar to those of the light emission control circuit according to the first embodiment. Therefore, the light emission control circuit according to the present embodiment can switch from a stopped state to an initiated state of current supply at different timings for each light emitting element, and prevent the increase in delay time from when the plurality of light emitting elements are controlled to be turned on till when the respective light emitting elements are actually turned on.

Furthermore, in the light emission control circuit according to the present embodiment, PWM control circuit 1 outputs a common control signal to switches SW1-SW3. By such a configuration, processing of PWM control circuit 1 can be simplified.

### Modifications

The present invention is not limited to the above-described embodiments, but also includes for example the following modifications.

(1) Cyclical Current Supply

Although the light emission control circuit according to the embodiment of the present invention has been described with PWM control circuit 1 which is configured to cyclically supply currents to light emitting elements D1-D3 based on the pulse width modulation method, the present invention is not limited thereto. PWM control circuit 1 can be configured to supply currents to light emitting elements D1-D3 intermittently rather than cyclically and to switch from a stopped state to an initiated state of current supply at different timings for each light emitting element. The object of the present invention can be achieved even if PWM control circuit 1 is configured in the above-described manner.

(2) PWM Control

Although the light emission control circuit according to the embodiment of the present invention has been described with PWM control circuit 1 which is configured to cyclically supply currents to light emitting elements D1-D3 based on the pulse width modulation method, the present invention is not limited thereto. PWM control circuit 1 can be configured to simply supply pulsed currents to light emitting elements D1-D3 at the fixed duty ratio and to switch from a stopped state to an initiated state of current supply at different timings for each light emitting element. The object of the present invention can be achieved even if PWM control circuit 1 is configured in the above-described manner.

It should be understood that the embodiments disclosed herein are illustrative and not limitative in any respect. The scope of the present invention is defined by the terms of the claims, rather than the embodiments and examples above, and is intended to include any modifications within the scope and meaning equivalent to the terms of the claims.

1. A light emission control circuit for turning on a plurality of light emitting elements comprising:
a current source circuit for generating currents to be supplied to said respective light emitting elements;
a plurality of switches corresponding to said respective light emitting elements for switching between supplying or not supplying the currents generated by said current source circuit to said respective light emitting elements; and
a control circuit for controlling said respective switches to intermittently supply the currents generated by said current source circuit to said respective light emitting elements and to switch from a stopped state to an initiated state of current supply at different timings for each said light emitting element.

2. The light emission control circuit according to claim 1, wherein
said control circuit is configured to supply the currents to said respective light emitting elements at an equal cycle and to set a different initiation timing of said cycle for each said light emitting element.

3. The light emission control circuit according to claim 2, wherein
said control circuit is configured to set the different initiation timing of said cycle for each said light emitting element at regular intervals.

4. The light emission control circuit according to claim 3, wherein
said interval is the time which is longer than or equal to the time required for the output voltage of a power supply circuit to become stabilized, wherein the power supply circuit is configured to apply voltages to said respective light emitting elements.

5. The light emission control circuit according to claim 1, wherein
said plurality of light emitting elements are LEDs to provide backlight of a display device employing the field sequential method.

6. The light emission control circuit according to claim 5, wherein
said plurality of light emitting elements are LEDs corresponding to the same color among the LEDs with a plurality of colors to provide backlight of a display device employing the field sequential method.

7. A light emission control circuit for turning on a plurality of light emitting elements comprising:
a current source circuit for generating currents to be supplied to said respective light emitting elements;
a plurality of switches corresponding to said respective light emitting elements for switching between supplying or not supplying the currents generated by said current source circuit to said respective light emitting elements;
a control circuit for controlling said respective switches to intermittently supply the currents generated by said current source circuit to said respective light emitting elements; and
a plurality of delay circuits corresponding to said respective light emitting elements for setting a different timing of switch control by said control circuit for each said light emitting element.

8. A lighting apparatus comprising:
a plurality of light emitting elements;
a current source circuit for generating currents to be supplied to said respective light emitting elements;
a plurality of switches corresponding to said respective light emitting elements for switching between supplying or not supplying the currents generated by said current source circuit to said respective light emitting elements; and
a control circuit for controlling said respective switches to intermittently supply the currents generated by said current source circuit to said respective light emitting elements and to switch from a stopped state to an initiated state of current supply at different timings for each said light emitting element.

9. A portable information terminal having a light emission control circuit for turning on a plurality of light emitting elements, said light emission control circuit comprising:
a current source circuit for generating currents to be supplied to said respective light emitting elements;
a plurality of switches corresponding to said respective light emitting elements for switching between supplying or not supplying the currents generated by said current source circuit to said respective light emitting elements; and
a control circuit for controlling said respective switches to intermittently supply the currents generated by said current source circuit to said respective light emitting elements and to switch from a stopped state to an initiated state of current supply at different timings for each said light emitting element.
